(19) United States
(12) Patent Application Publication
(10) Pub. No.: US 2018/0164412 A1
(43) Pub. Date: Jun. 14, 2018

(54) LiDAR Apparatus

(71) Applicant: SensL Technologies Ltd., County Cork (IE)

(72) Inventors: Salvatore Gnecchi, Cork (IE); John Carlton Jackson, Co. Cork (IE)

(73) Assignee: SensL Technologies Ltd., County Cork (IE)

(21) Appl. No.: 15/383,328

(22) Filed: Dec. 19, 2016

Related U.S. Application Data
(63) Continuation-in-part of application No. 15/377,289, filed on Dec. 13, 2016.

(51) Int. Cl. G01S 7/481; G01S 7/484

(52) U.S. Cl. CPC G01S 7/4814; G01S 7/484; G01S 7/4816

(57) ABSTRACT

A LiDAR apparatus is described. The apparatus comprises an eye safe laser source for emitting laser pulses. An SiPM detector is provided for detected reflected photons; and optics are also provided. The eye-safe laser source is configured such that the emitted laser pulses have a width which are selectively matched to a desired range accuracy.

### CROSS REFERENCE TO RELATED APPLICATION

This application is a continuation-in-part of U.S. patent application Ser. No. 15/377,289 filed on Dec. 13, 2016, still pending.

### FIELD OF THE INVENTION

The invention relates to a LiDAR apparatus. In particularly but not exclusively the present disclosure relates to a LiDAR apparatus which includes an eye-safe laser source configured such that the emitted laser pulses have a width which are matched to a desired range accuracy.

### BACKGROUND

A Silicon Photomultiplier (SiPM) is a single-photon sensitive, high performance, solid-state sensor. It is formed of a summed array of closely-packed Single Photon Avalanche Photodiode (SPAD) sensors with integrated quench resistors, resulting in a compact sensor that has high gain (˜1×10⁶), high detection efficiency (>50%) and fast timing (sub-ns rise times) all achieved at a bias voltage of ˜30V.

Typical state-of-the art ToF LiDAR systems use either pulsed or continuous illumination. The latter uses a continuously time varying signal which can be represented as a sinusoidal signal. To detect the range of the target it is required to acquire the signal and determine any phase angle shift between the outgoing and the incoming signal. This shift is then used to calculate the distance from the source to the target. By nature of operation it is required to detect the peak and troth of the sinusoidal signal. This requirement to detect both the peak and the troth of the signal wastes photons since not all detected photons are used in the determination of the target distance. This requires high optical powers, potentially non-eye-safe signal sources to be used for long distance detection of low reflectivity targets.

There is therefore a need to provide for a LiDAR system which utilises a Geiger mode detector which addresses at least some of the drawbacks of the prior art.

### SUMMARY

Accordingly, the present disclosure relates to a LiDAR apparatus comprising:
an eye safe laser source for emitting laser pulses;
a Geiger mode detector for detected reflected photons;
optics;

wherein the eye-safe laser source is configured such that the emitted laser pulses have a width which are selectively matched to a desired range accuracy.

In one aspect, an average power of the laser pulses is fixed to meet eye-safety limitations.

In another aspect, the eye-safe laser source is configured to vary the pulse width in order to achieve a predetermined average power.

In a further aspect, the eye-safe laser source is configured to apply a higher laser peak power with the same predetermined average power by reducing the pulse width of the laser pulses.

In another aspect, the eye-safe laser source is configured to apply a lower laser peak power with the same predetermined average power by increasing the pulse width of the laser pulses.

In an exemplary aspect, the laser peak power is calculated using the equation:

$${P}_{peak} = \frac{{P}_{avg}}{{T}_{pw} \times PRR}$$

Where:
P_{avg} is the average power of a laser pulse;
T_{pw} is the pulse width; and
PRR is repetition rate.

In a further aspect, the eye-safe laser source is configured such that the emitted laser pulses have a width which are matched to a desired detection resolution such that every emitted photon that is detected contributes to the range accuracy.

In another aspect, the required pulse width is calculated from the desired range accuracy using the equation:

$$t = \frac{Δ d * 2}{c} ,$$

### Where

Δd is the desired range accuracy;

c is the speed of light; and

t is the required laser pulse width.

In a further aspect, for a desired range accuracy of 10 cm the laser pulse width is set to 667 picoseconds.

In one aspect, the Geiger mode detector is a single-photon sensor.

In a further aspect, the Geiger mode detector is formed of a summed array of Single Photon Avalanche Photodiode (SPAD) sensors.

In an exemplary arrangement, a controller is provided which is co-operable with the eye-safe laser for controlling the eye-safe laser such that the emitted laser pulses have a width which are matched to a desired range accuracy.

In another aspect, the controller is programmable for setting the desired range accuracy.

In one aspect, the width of the laser pulses are less than 1 nanosecond.

In a further aspect, the optics comprises a receive lens.

In another aspect, the optics comprises a transmit lens.

In an exemplary arrangement, the optics comprise a beam splitter such that a single lens is utilised as a transmit lens and a receive lens.

In one aspect, the beam splitter comprises a polarising mirror located intermediate the single lens and the SiPM detector.

In a further aspect, an aperture stop is located intermediate the Geiger mode detector and the optics.

In one aspect, the aperture stop is located at the focal point of the optics.

In another aspect, the aperture stop has dimensions to match a required angle of view which is based on the size of the active area of the Geiger mode detector.

In a further aspect, the angle of view is less than 1 degree.

In an exemplary aspect, the aperture stop diffuses light collected by the optics over a total active area of the Geiger mode detector.

In one aspect, for a given focal length f, the angle of view θ of the Geiger mode detector placed on the focal point and with a length L is given by:

$${θ}_{x , y} = 2 \times atan ( \frac{{L}_{x , y} / 2}{f} )$$

### Where:

Focal length of receiver lens: f
Sensor horizontal and vertical length: Lₓ, L_{y};
Sensor angle of view: θ_{x,y}

In another aspect, wherein the aperture stop has dimensions to match the required angle of view according to:

$${P}_{x , y} = 2 \times f \times tan ( \frac{{θ}_{x , y}}{2} )$$

### Where:

Focal length of receiver lens: f
Sensor angle of view: θ_{x,y}
Aperture stop size: P_{x,y}

In one aspect, a controller is co-operable with the eye-safe laser source for controlling the eye-safe laser source such that the emitted laser pulses have a width which are matched to a desired range accuracy.

These and other features will be better understood with reference to the followings Figures which are provided to assist in an understanding of the present teaching.

### BRIEF DESCRIPTION OF THE DRAWINGS

The present teaching will now be described with reference to the accompanying drawings in which:

FIG. 1 illustrates an exemplary structure of a silicon photomultiplier.

FIG. 2 is a schematic circuit diagram of an exemplary silicon photomultiplier.

FIG. 3 illustrates an exemplary technique for a direct ToF ranging.

FIG. 4 illustrates an exemplary ToF ranging system.

FIG. 5 illustrates an histogram generated using the ToF ranging system of FIG. 4.

FIG. 6 illustrates an exemplary LiDAR apparatus incorporating an SiPM detector.

FIG. 6A illustrates details of the LiDAR apparatus of FIG. 6.

FIG. 7 illustrates details of a LiDAR apparatus in accordance with the present teaching.

FIG. 8 illustrates details of a LiDAR apparatus in accordance with the present teaching.

FIG. 9 illustrates another LiDAR apparatus which is also in accordance with the present teaching.

FIG. 10 illustrates a laser pulse width diagram of a prior art LiDAR system.

FIG. 11 illustrates a laser pulse width diagram of a LiDAR apparatus in accordance with the present teaching.

### DETAILED DESCRIPTION

The present disclosure will now be described with reference to an exemplary LiDAR apparatus which utilises Geiger mode detector technology. It will be understood that the exemplary LiDAR system is provided to assist in an understanding of the teaching and is not to be construed as limiting in any fashion. Furthermore, circuit elements or components that are described with reference to any one Figure may be interchanged with those of other Figures or other equivalent circuit elements without departing from the spirit of the present teaching. It will be appreciated that for simplicity and clarity of illustration, where considered appropriate, reference numerals may be repeated among the figures to indicate corresponding or analogous elements.

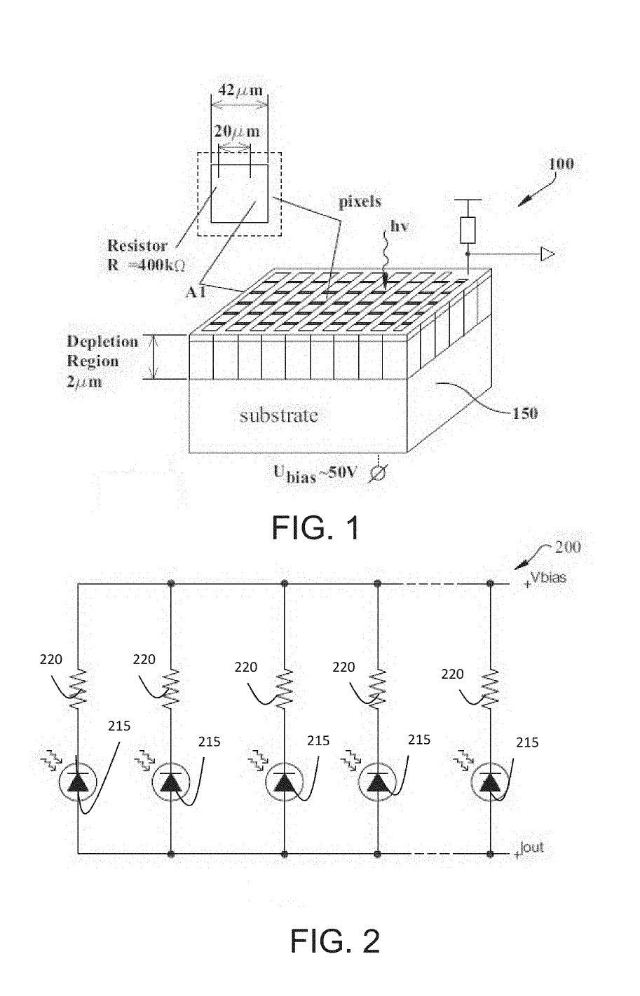

Referring initially to FIG. 1, a silicon photomultiplier 100 comprising an array of Geiger mode photodiodes is shown. As illustrated, a quench resistor is provided adjacent to each photodiode which may be used to limit the avalanche current. The photodiodes are electrically connected to common biasing and ground electrodes by aluminium or similar conductive tracking. A schematic circuit is shown in FIG. 2 for a conventional silicon photomultiplier 200 in which the anodes of an array of photodiodes are connected to a common ground electrode and the cathodes of the array are connected via current limiting resistors to a common bias electrode for applying a bias voltage across the diodes. The silicon photomultiplier 100 may be used as a Geiger mode detector in accordance with the present teaching. It is not intended to limit the present teaching to the exemplary Geiger mode detector described in the exemplary embodiment as other Geiger mode detectors may be utilised such as single-photon avalanche diodes (SPADs) or the like.

The silicon photomultiplier 100 integrates a dense array of small, electrically and optically isolated Geigermode photodiodes 215. Each photodiode 215 is coupled in series to a quench resistor 220. Each photodiode 215 is referred to as a microcell. The number of microcells typically number between 100 and 3000 per mm². The signals of all microcells are then summed to form the output of the SiPM 200. A simplified electrical circuit is provided to illustrate the concept in FIG. 2. Each microcell detects photons identically and independently. The sum of the discharge currents from each of these individual binary detectors combines to form a quasi-analog output, and is thus capable of giving information on the magnitude of an incident photon flux.

Each microcell generates a highly uniform and quantized amount of charge every time the microcell undergoes a Geiger breakdown. The gain of a microcell (and hence the detector) is defined as the ratio of the output charge to the charge on an electron. The output charge can be calculated from the over-voltage and the microcell capacitance.

$$G = \frac{C \cdot Δ V}{q}$$

### Where:

G is the gain of the microcell;
C is the capacitance of the microcell;
ΔV is the over-voltage; and
q is the charge of an electron.

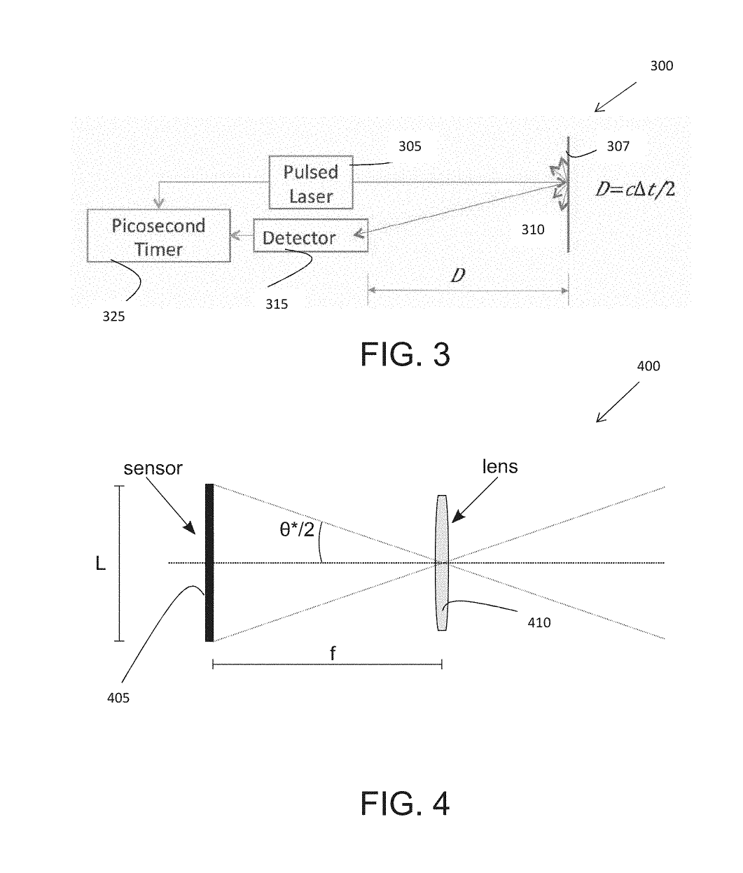

LiDAR is a ranging technique that is increasingly being employed in applications such as mobile range finding, automotive ADAS (Advanced Driver Assistance Systems), gesture recognition and 3D mapping. Employing a Geiger mode detector such as a SiPM sensor has a number of advantages over alternative sensor technologies such as avalanche photodiode (APD), PIN diodes and photomultiplier tubes (PMT) particularly for mobile and high volume products. The basic components typically used for a direct ToF ranging system, are illustrated in FIG. 3. In the direct ToF technique, a periodic laser pulse 305 is directed at the target 307. The target 307 diffuses and reflects the laser photons and some of the photons are reflected back towards the detector 315. The detector 315 converts the detected laser photons (and some detected photons due to noise) to electrical signals that are then timestamped by timing electronics 325.

This time of flight, t, may be used to calculate the distance, D, to the target from the equation

D=cΔt/2, Equation 1
where c=speed of light; and
Δt=time of flight.
   The detector 315 must discriminate returned laser photons from the noise (ambient light). At least one timestamp is captured per laser pulse. This is known as a single-shot measurement. The signal to noise ratio may be significantly improved when the data from many singleshot measurements are combined to produce a ranging measurement from which the timing of the detected laser pulses can be extracted with high precision and accuracy.

Referring now to FIG. 4 which shows an exemplary SiPM sensor 400 which comprises an array of Single Photon Avalanche Photodiodes (SPAD) defining a sensing area 405. A lens 410 is provided for providing corrective optics. For a given focal length f of a lens system, the angle of view θ of a sensor placed on the focal point and with length L is given by:

$${θ}_{x , y} = 2 \times atan ( \frac{{L}_{x , y} / 2}{f} ) \qquad Equation 2$$

### Where:

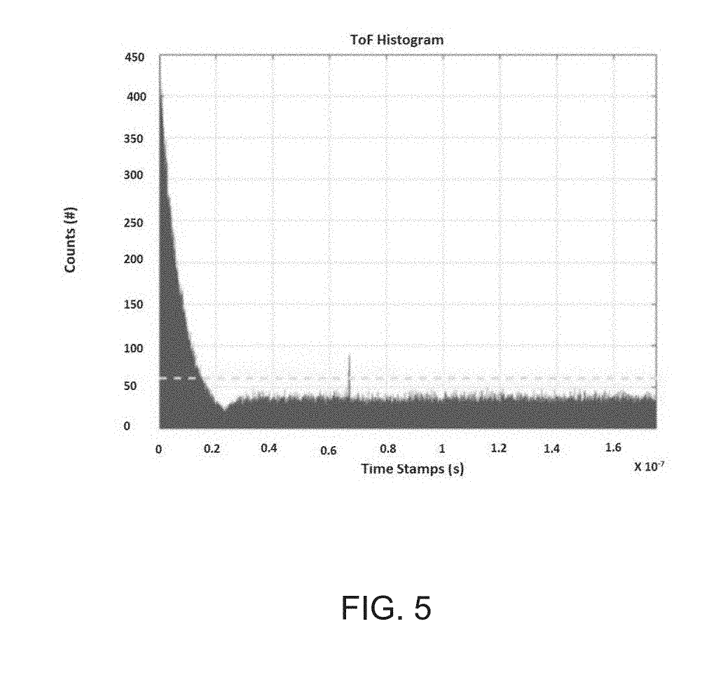

f is the focal length of receiver lens:
Lₓ, L_{y} is sensor horizontal and vertical length; and
θ_{x,y} is the SiPM detector angle of view.
   This means that a large sensor has a large angle of view when a short focal length is used. When the lens aperture is widened, more ambient photons are detected while the number of returned laser photons remains constant. The SiPM 400 is prone to saturation as is evident from the large overshoot at the start of the histogram window in FIG. 5. When the sensor 400 is saturated the laser photons can no longer be detected by the SiPM 400, leading to a lower signal detection rate and lower overall SNR_{H}.

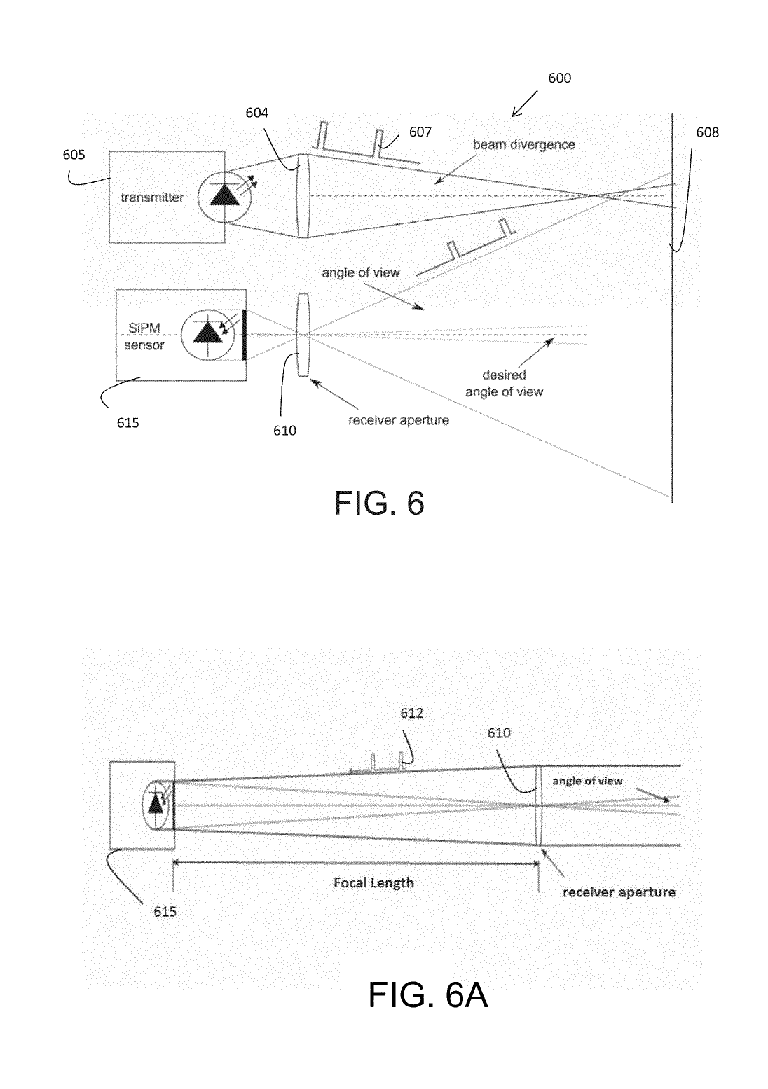

FIG. 6 illustrates an exemplary LiDAR system 600. Which includes a laser source 605 for transmitting a periodic laser pulse 607 through a transmit lens 604. A target 608 diffuses and reflects laser photons 612 through a receive lens 610 and some of the photons are reflected back towards a SiPM sensor 615. The SiPM sensor 615 converts the detected laser photons and some detected photons due to noise to electrical signals that are then timestamped by timing electronics. In order to avoid the SiPM sensor 610 reaching saturation point, the focal length is required to be kept relatively long. For a given focal length f of a lens system, the angle of view θ of the SiPM sensor 615 placed on the focal point and with length L is given by equation 2. Thus a large sensor requires a large angle of view when a short focal length is used as illustrated in FIG. 6A. Large angles of view (AoV), in the orders of many tens of degrees, up to 90°+, are used in state-of-the-art LiDAR sensors where the detector stares at the scene while a laser typically scans the scene for angular resolution. These sensors are typically based on PIN and avalanche diodes which have strong ambient light rejection. However, the signal to noise ratio SNR is highly affected by large angles of view since the noise level is set by the receiver AoV limiting the accuracy of the LiDAR system. Moreover, these devices are not suitable for long ranging LiDAR where the number of returned photons requires single photon detection efficiency.

SiPM detectors using short angle of view SPAD or SiPM sensors satisfy the single photon detection efficiency requirement. Short AoV sensors, i.e. <1 degree, may be either used as single point sensors in scanning systems to cover larger total AoV or arranged in arrays. SPAD/SiPMs sensors however suffer from limited dynamic range due to a necessary recovery/recharge process of the sensors. At every photo detection in a microcell of the SiPM, the avalanche process needs to be quenched through, for example, a resistor which discharges the photocurrent and brings the diode out of the breakdown region. Then a recharge, passive or active, process begins to restore the diode bias voltage restoring the initial conditions ready for the next photo detection. The amount of time during which the quenching and recharge process take place is commonly referred to as dead time or recovery time. No further detections can happen in this time window due to the bias condition of the diode being outside the Geiger mode. In a SiPM, when a microcell enters the dead time window, the other microcells can still detect photons. Hence, the number of microcells define the photon dynamic range of the sensor allowing higher number of photons per unit time to be detected. When no microcells are available for detection due to dead time, the SiPM is said to be in its saturation region. A high number of diodes within an SiPM (microcells) is necessary to compensate the recovery process which inhibits the involved units of the detector. Large SiPMs provide high dynamic range. The size of the SiPM together with the focal length of the received sets the angle of view as per equation 2 and as illustrated in FIG. 6A.

SiPM detectors suffer from saturation in high ambient light conditions due to detector dead time. The present disclosure addresses this problem by limiting the angle of view (AoV) of the SiPM detector in order to avoid collecting undesirable noise, i.e. uncoherent ambient light. A short angle of view for a large sensor requires long focal lengths in a single-lens optical system. Such focal lengths are not suitable for LiDAR systems required to operate in compact environments where the available space is 10 cm or less. The present solution pairs an SiPM sensor that operates as a Geiger mode detector with a receiver lens and an aperture stop element which limits the AoV and reduces the focal length requirements thereby allowing SiPM sensors to be incorporated into LiDAR systems that operate in compact environment. The aperture stop element stops the light coming from a large angle of view and spreads the collected light over the entire area of the SiPM effectively reaching the detection efficiency of a long focal length lens arrangement.

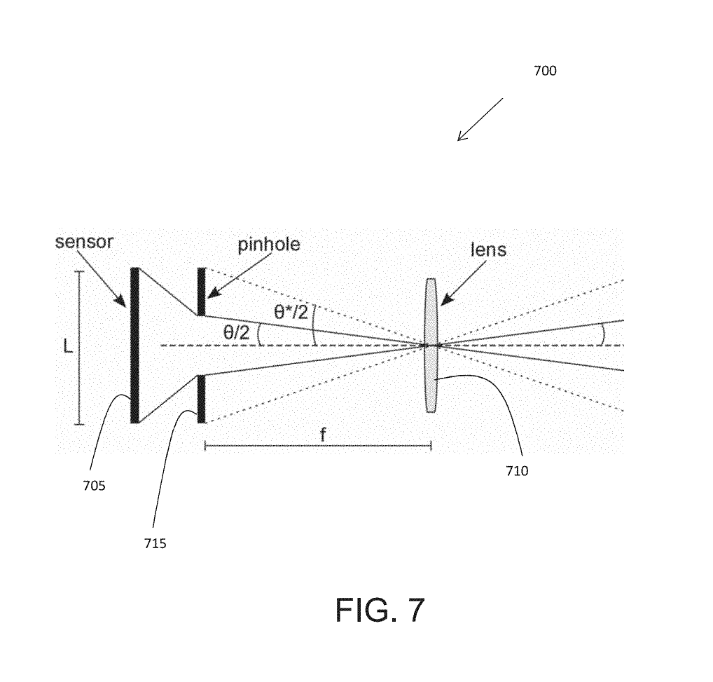

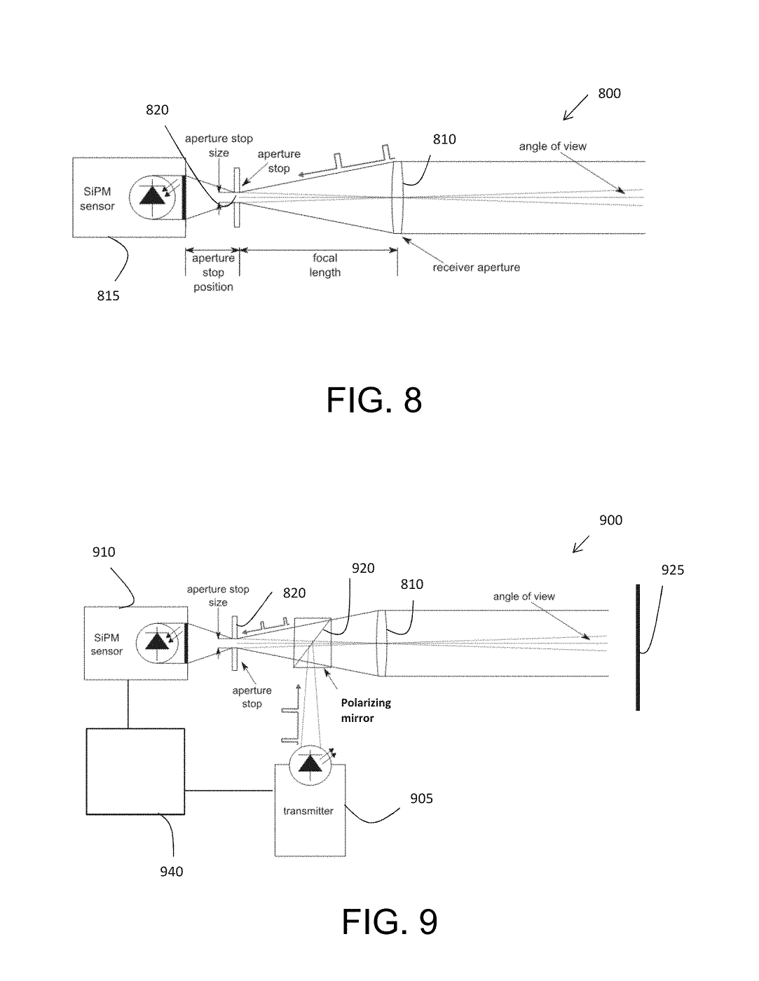

Referring now to FIG. 7 which shows an exemplary SiPM sensor 700 which may be incorporated into a LiDAR apparatus in accordance with the present teaching. The SiPM sensor 700 comprises an array of Single Photon Avalanche Photodiodes (SPAD) defining a sensing area 705. A lens 710 is provided for providing corrective optics. An aperture stop 715 is provided intermediate the lens 710 and the sensing area 705 which blocks the light coming from a larger angle and diffuses the collected light onto the sensor area 705 overcoming therefore the need of longer focal lengths. An aperture is an opening or hole which facilitates the transmission of light there through. The focal length and aperture of an optical apparatus determines the cone angle of a plurality of rays that arrive to a focus in an image plane. The aperture collimates the light rays and is very important for image quality. When an aperture is narrow, highly collimated rays are admitted through which results in a sharp focus at the image plane. However, when the aperture is wide uncollimated rays are admitted through the aperture which limits the sharp focus for certain rays arriving from a certain distance. Thus, a wide aperture results in a sharp image for objects at a certain distance. The amount of incoming rays are also determined by the size of the aperture. An optical apparatus may have elements that limit the ray bundles. In optic these elements are used to limit the light admitted by the optical apparatus. These elements are commonly referred to as stops. An aperture stop is the stop that sets the ray cone angle and brightness at the image point. The focal length of the optics of the SiPM 700 may be significantly less than that of the optics of SiPM 400 as a result of the aperture stop 715.

In order to reduce the angle of view while maintaining the dynamic range required for given accuracy and ranging accuracy, a large sensor is typically paired with a long focal length lens aperture, as illustrated in FIG. 6A. Long focal lengths ˜10+ cm are however not appealing for compact systems where the maximum length is typically ˜10 cm or less. Applications that require compact LiDAR systems includes autonomous automobiles, Advanced Driver Assistance Systems (ADAS), and 3D Imaging. The present solution provides a LiDAR apparatus 800 which utilizes the benefits for SPAD/SiPM technology and is suitable for being accommodated in a compact environments by incorporating an aperture stop element 820. The aperture stop element 820 is located between the sensor 815 and a short focal length lens 810. The aperture stop 820 has two primary functions. Firstly, the aperture stop is used to block the light coming from an original larger angle. The size of the aperture stop is based on the size of the sensor area and the focal length. Secondly, the aperture stop diffuses the collected light over the total active area of the sensor to exploit the dynamic range available due to the large sensor.

The dimensions and the position of the aperture stop relate both to the size of the sensor area and the desired angle of view and the focal length of the receiver lens. The dimension P_{x,y} may match the required angle of view according to:

$${P}_{x , y} = 2 \times f \times tan ( \frac{{θ}_{x , y}}{2} ) \qquad Equation 3$$

While the sensor is placed at a certain distance to ensure the diffusion of the light of the entire active area:

$$x = f \times \frac{{L}_{x}}{{D}_{lems}} \qquad Equation 4$$

Wherein: f is focal length of receiver lens;
θ_{x,y} is the sensor angle of view;
P_{x,y} is aperture stop dimension; and
Dₗₑₙₛ is diameter of receiver lens.

The light may spread uniformly over the sensor active area; however, no imaging ability is required as the system is a single point sensor. Note that the given equations represent theoretical maxima and are provide by way of example. The distances may need adjustment in order to take account of tolerances.

Referring now to FIG. 9 which illustrates an exemplary LiDAR apparatus 900 which is also in accordance with the present teaching. The LiDAR apparatus 900 is substantially similar to the LiDAR apparatus 800 and similar elements are indicated by similar reference numerals. The main difference is that the LiDAR apparatus 900 includes shared optics for the transmitter 905 and the receiver 910. A beam splitter provided by a polarizing mirror 920 is provided intermediate the lens 810 and the aperture stop 820. The polarising mirror reflects the laser beam onto the scene and directs the reflected lights onto the SiPM sensor 910

It will be appreciated by those of ordinary skill in the art that by utilizing an aperture stop allows the LiDAR systems 800 and 900 to have a short focal length while utilizing a large sensor area in the order of 1 mm² or greater. Since the LiDAR apparatus of the present teaching utilizes an optical system with a short focal length it allows the LiDAR system to be incorporated into compact environments having a length of 10 cm or less between the detector and receiver optics. The following table provides some exemplary dimensions for the components of the LiDAR apparatus in accordance with the present teaching. The exemplary dimensions are provided by way of example only and it is not intended to limit the present teaching to the exemplary dimensions provided.

| | | | Aperture |
|---|---|---|---|
| Active Area of | Distance of aperture stop | | stop |
| SiPM sensor | from SiPM sensor | Angle of view | dimensions |
| 1 mm² | 0.197 mm | 0.1° | 87.3 μm |
| 3 mm² | 0.59 mm | 0.5° | 436 μm |
| 6 mm² | 1.18 mm | 1° | 873 μm |

Examples for a 1 inch lens with a 5 cm focal length

The LiDAR apparatus 900 may operate as a time of flight (ToF) LiDAR system such that a laser pulse exits a transmitter 905 at a known time. After the laser pulse strikes a target 925, reflected light is returned to the receiver 910. If the target 925 has a mirror like surface, then specular reflection will reflect photons in an angle equivalent to the incidence angle. This can result in the maximum number of photons reflected by the target being detected at the receiver 910. Standard avalanche photodiode (APD) sensors can be used to detect light from a retroreflector which reflects light back along the incident path, irrespective of the angle of incidence. However, most surfaces in the real world are non-specular targets and do not directly reflect the incident light. These non-specular surfaces can typically be represented as a Lambertian surface. When a Lambertian surface is viewed by a receiver with a finite angle of view (AoV) the quantity of photons received is invariant with the angle viewed and the photons are spread across a 2n steradian surface. The net impact of a Lambertian reflector is that the number of returned photons is proportional to 1/distance². Additionally, the number of transmitted photons are limited by eye-safety constraints. Due to the 1/distance² reduction in the number of photons returned and the inability to simply increase the source power it is desired that every photon detected contributes to the overall accuracy of the LiDAR system 900.

Typical state-of-the art ToF LiDAR systems use either pulsed or continuous illumination. The latter uses a continuously time varying signal which can be represented as a sinusoidal signal. To detect the range of the target it is required to acquire the signal and determine any phase angle shift between the outgoing and the incoming signal. This shift is then used to calculate the distance from the source to the target. By nature of operation it is required to detect the peak and troth of the sinusoidal signal. The prior art requirement to detect both the peak and the troth of the signal wastes photons since not all detected photons are used in the determination of the target distance. This requires high optical powers, potentially non-eye-safe signal sources to be used which for long distance detection of low reflectivity targets.

An alternative method for ToF LiDAR is to use a pulsed signal source and detect the direct time of flight between the time the signal source was turned on and the time that the pulse is detected at the receiver. An important distinction between direct and indirect ToF LiDAR systems is that a direct ToF system only requires the first detected photon to accurately determine the distance to the target. Taking advantage of this difference allows a direct ToF LiDAR system to accurately determine the target distance using a smaller number of returned photons. Therefore, to provide target ranging over the same distance a direct ToF system can use a lower pulsed source than a continuous illumination system.

The width of the pulse has two main implications for long distance LiDAR systems. First, the laser pulse width must match the bandwidth of the detector. State-of-the-art LiDAR systems based on linear photo diodes are bandwidth limited and require pulse widths of four or more nanosecond to sufficiently capture the return signal. When the strength of the received pulse get lower, as with long distance low reflectivity targets, the pulse width also becomes a dominant factor in the accuracy of the sensor. The detection of the pulse can be triggered at a random time point within the laser pulse. A long pulse therefore translates into a lower accuracy of the measurement.

High bandwidth sensors such as SPADs/SiPMs can operate at lower pulse widths due to a non-linear mode of operation and low rise time. It is useful to calculate the optimum pulse width for the target range accuracy which allows for the lower power light source to be used. Given that light travels at c, the speed of light, or 299,792,458 m/s and that the distance, d, between the target and the LiDAR system can be determined by the following formula

$$d = \frac{Δ t * c}{2} , \qquad Equation 5$$

where Δt is the time difference between the application of the light source towards the target and the receipt of returned light from the target at the receiver.

This equation can be rewritten to determine the required time difference between the application of the light source and the returned being detected at the receiver, or t. This can be expressed by the following formula:

$$t = \frac{Δ d * 2}{c} , \qquad Equation 6$$

where Δd is the range accuracy required. Thus for a desired range accuracy of 10 cm, then a laser pulse width of 667 ps is desired, for example.

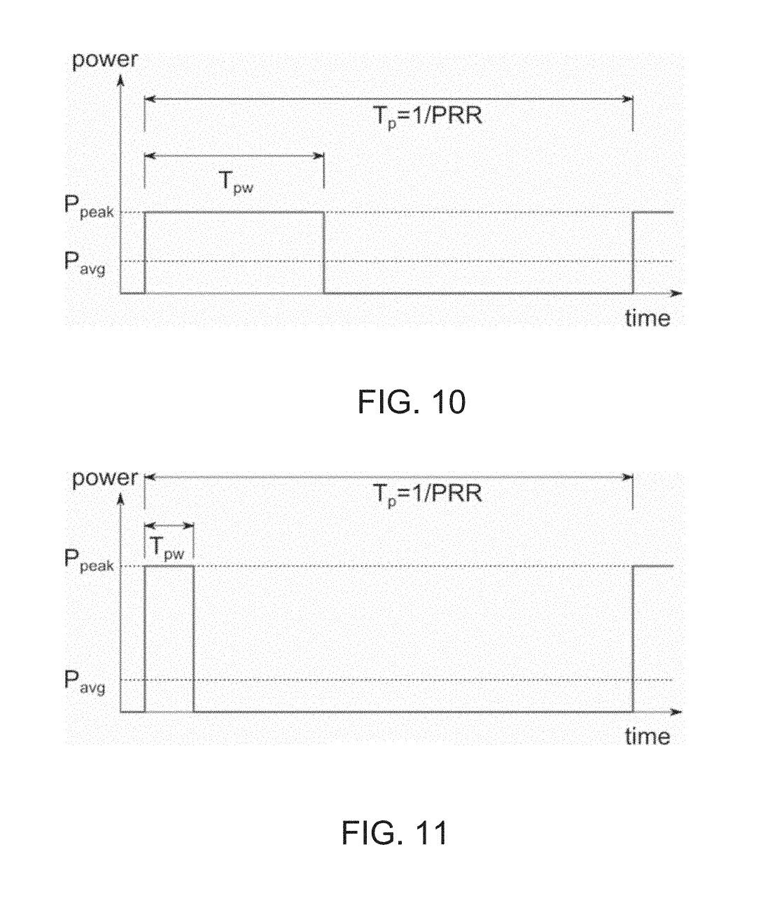

The reduction of the pulse allows a higher peak power to be achieved maintaining the same average power, critical for eye-safety calculations. Referring to FIG. 10, the average power of a laser pulse can be calculated from its repetition rate PRR, the pulse width T_{pw} and the peak power Pₚₑₐₖ:

$${P}_{avg} = {P}_{peak} \times \frac{{T}_{pw}}{{T}_{p}} = {P}_{peak} \times {T}_{pw} \times PRR \qquad Equation 7$$

Fixing the average power due to eye-safety limitations, the peak power is calculated as

$${P}_{peak} = \frac{{P}_{avg}}{{T}_{pw} \times PRR} \qquad Equation 8$$

And therefore a higher laser peak power can be achieved with the same average power by lowering the pulse width, as illustrated in FIG. 11.

The present disclosure describes a LiDAR apparatus 800 comprising an eye safe laser source 900 for emitting laser pulses. An SiPM detector 910 detects reflected photons from a target 925. A lens 810 provides optics. A controller 940 is co-operable with the eye-safe laser 900 for controlling the eye-safe laser source 900 such that the emitted laser pulses have a width which are selectively matched to a desired range accuracy. The controller 940 controls the laser source such that the average power of the laser pulses is fixed to meet eye-safety limitations. Laser source eye-safety limitations are detailed in standards set forth by the American National Standards Institute (Ansi) Z136 series or the International standard IEC60825, for example. Thus, it is envisage that the laser source 905 is compatible with the Ansi Z136 or IEC60825 standards. The average power of the laser pulses may be fixed to meet eye-safety standards set as set forth in at least one the AnsiZ136 and IEC60825 standards. It is not intended to limit the present teaching to the exemplary eye safety standards provided which are provided by way of example.

The controller 940 is operable to control the laser source such that the eye-safe laser source is configured to vary the pulse width in order to achieve a predetermined average power. For example, the eye-safe laser source applies a higher laser peak power with the same predetermined average power by reducing the pulse width of the laser pulses. Alternatively, the eye-safe laser source applies a lower laser peak power with the same predetermined average power by increasing the pulse width of the laser pulses. The eye-safe laser source may be configured such that the emitted laser pulses have a width which are matched to a desired detection resolution such that every emitted photon that is detected contributes to the desired range accuracy. For example, for a desired range accuracy of 10 cm the laser pulse width is set to 667 picoseconds. The controller 940 is programmable for setting the desired range accuracy. In an exemplary embodiment, the width of the laser pulses are less than 1 nanosecond.

It will be appreciated by the person of skill in the art that various modifications may be made to the above described embodiments without departing from the scope of the present invention. In this way it will be understood that the teaching is to be limited only insofar as is deemed necessary in the light of the appended claims. The term semiconductor photomultiplier is intended to cover any solid state photomultiplier device such as Silicon Photomultiplier [SiPM], MicroPixel Photon Counters [MPPC], MicroPixel Avalanche Photodiodes [MAPD] but not limited to.

Similarly the words comprises/comprising when used in the specification are used to specify the presence of stated features, integers, steps or components but do not preclude the presence or addition of one or more additional features, integers, steps, components or groups thereof.

What is claimed is:

1. A LiDAR apparatus comprising:
an eye safe laser source for emitting laser pulses;
a Geiger mode detector for detected reflected photons; and
optics;
wherein the eye-safe laser source is configured such that the emitted laser pulses have a width which are selectively matched to a desired range accuracy.

2. The LiDAR apparatus of claim 1, wherein an average power of the laser pulses is fixed to meet eye-safety standards set forth in at least one of the AnsiZ136 and IEC60825 standards.

3. The LiDAR apparatus of claim 1, wherein the eye-safe laser source is configured to vary the pulse width in order to achieve a predetermined average power.

4. The LiDAR apparatus of claim 3, wherein the eye-safe laser source is configured to apply a higher laser peak power with the same predetermined average power by reducing the pulse width of the laser pulses.

5. The LiDAR apparatus of claim 3, wherein the eye-safe laser source is configured to apply a lower laser peak power with the same predetermined average power by increasing the pulse width of the laser pulses.

6. The LiDAR apparatus of claim 3, wherein the laser peak power is calculated using the equation:
$${P}_{peak} = \frac{{P}_{avg}}{{T}_{pw} \times PRR}$$
Where:
P_{avg} is the average power of a laser pulse;
T_{pw} is the pulse width; and
PRR is repetition rate.

7. The LiDAR apparatus of claim 1, wherein the eye-safe laser source is configured such that the emitted laser pulses have a width which are matched to a desired detection resolution such that every emitted photon that is detected contributes to the desired range accuracy.

8. The LiDAR apparatus of claim 1, wherein the desired laser pulse width is calculated using the equation:
$$t = \frac{Δ d * 2}{c} ,$$
Where
Δd is the desired range accuracy;
c is the speed of light; and
t is the pulse width of the laser.

9. The LiDAR apparatus of claim 8, wherein for a desired range accuracy of 10 cm the laser pulse width is set to 667 picoseconds.

10. The LiDAR apparatus as claimed in claim 1, wherein the Geiger mode detector is a single-photon sensor.

11. The LiDAR apparatus as claimed in claim 1, wherein the Geiger mode detector is formed of a summed array of Single Photon Avalanche Photodiode (SPAD) sensors.

12. The LiDAR apparatus as claimed in claim 1, further comprising a controller which is co-operable with the eye-safe laser for controlling the eye-safe laser source such that the emitted laser pulses have a width which are matched to a desired range accuracy.

13. The LiDAR apparatus as claimed in claim 12, wherein the controller is programmable for setting the desired range accuracy.

13. The LiDAR apparatus as claimed in claim 1, wherein the width of the laser pulses are less than 1 nanosecond

15. The LiDAR apparatus as claimed in claim 1, wherein the optics comprises a receive lens.

16. The LiDAR apparatus as claimed in claim 15, wherein the optics comprises a transmit lens.

17. The LiDAR apparatus as claimed in claim 1, wherein the optics comprise a beam splitter such that a single lens is utilised for transmitting and receiving.

18. The LiDAR apparatus as claimed in claim 17, wherein the beam splitter comprises a polarising mirror located intermediate the single lens and the Geiger mode detector.

19. The LiDAR apparatus as claimed in claim 1, wherein an aperture stop is located intermediate the Geiger mode detector and the optics.

20. The LiDAR apparatus as claimed in claim 1, wherein the aperture stop is located at the focal point of the optics.

21. The LiDAR apparatus as claimed in claim 20, wherein the aperture stop has dimensions to match a required angle of view which is based on the size of the active area of the SiPM detector.

22. The LiDAR apparatus as claimed in claim 21, wherein the angle of view is less than 1 degree.

23. The LiDAR apparatus as claimed in claim 19, wherein the aperture stop diffuses light collected by the optics over a total active area of the SiPM detector.

24. The LiDAR apparatus as claimed in claim 21, wherein for a given focal length f, the angle of view θ_{x,y} of the SiPM detector placed on the focal point and with a length L is given by:
$${θ}_{x , y} = 2 \times atan ( \frac{{L}_{x , y} / 2}{f} )$$
Where:
Focal length of receiver lens: f
Sensor horizontal and vertical length: Lₓ, L_{y};
Sensor angle of view: θ_{x,y}

25. The LiDAR apparatus as claimed in claim 21, wherein the aperture stop has dimensions to match the required angle of view according to:
$${P}_{x , y} = 2 \times f \times tan ( \frac{{θ}_{x , y}}{2} )$$
Where:
Focal length of receiver lens: f
Sensor angle of view: θ_{x,y}
Aperture stop size: P_{x,y}
